(19) United States
(12) Patent Application Publication
(10) Pub. No.: US 2024/0248332 A1
(43) Pub. Date: Jul. 25, 2024

(54) ELECTRO-OPTIC MODULATOR, MANUFACTURING METHOD THEREOF, AND OPTICAL COMMUNICATION SYSTEM

(71) Applicant: HUAWEI TECHNOLOGIES CO., LTD., Shenzhen (CN)

(72) Inventors: Shiyang Zhu, Singapore (SG); Zhanshi Yao, Shenzhen (CN); Xiang Yin, Shenzhen (CN)

(21) Appl. No.: 18/607,089

(22) Filed: Mar. 15, 2024

Related U.S. Application Data
(63) Continuation of application No. PCT/CN2022/107354, filed on Jul. 22, 2022.

(30) Foreign Application Priority Data
Sep. 18, 2021 (CN) 202111112398.4

(51) Int. Cl. G02F 1/065; G02F 1/025; G02F 1/035

(52) U.S. Cl. CPC G02F 1/065; G02F 1/025; G02F 1/035

(57) ABSTRACT

An electro-optic modulator, a manufacturing method thereof, and an optical communication system are provided. The electro-optic modulator includes a substrate and a dielectric layer located on a side of the substrate. An organic waveguide and electrodes on two sides of the organic waveguide are disposed in the dielectric layer. A refractive index of the organic waveguide is greater than a refractive index of the dielectric layer. A material of the organic waveguide is an organic material having electro-optic effect. A dielectric waveguide is disposed in the organic waveguide. The dielectric waveguide and the organic waveguide form a composite waveguide. A refractive index of the dielectric waveguide is greater than the refractive index of the organic waveguide.

### CROSS-REFERENCE TO RELATED APPLICATIONS

This application is a continuation of International Application No. PCT/CN2022/107354, filed on Jul. 22, 2022, which claims priority to Chinese Patent Application No. 202111112398.4, filed on Sep. 18, 2021. The disclosures of the aforementioned applications are hereby incorporated by reference in their entireties.

### TECHNICAL FIELD

Embodiments of this application relate to the field of optical communication technologies, and in particular, to an electro-optic modulator, a manufacturing method thereof, and an optical communication system.

### BACKGROUND

With continuous emergence and popularization of emerging services such as the Internet of Things, big data, cloud computing, 5G, and the like, a total amount of data transmission increases sharply. As a result, an existing optical communication system faces a great bearing stress. How to continuously improve a bandwidth and efficiency of a transmission system is a focus of optical communication technology development.

An electro-optic modulator is one of key devices in a photonic integrated circuit (PIC) or an electronic-photonic integrated circuit (EPIC), and functions to load an electrical signal to light transmitted in a waveguide, that is, to modulate a phase or intensity of the light. As an important device in the optical communication system, the electro-optic modulator is also an important factor that determines a bandwidth of the optical communication system. Requirements for the electro-optic modulator include a high modulation bandwidth, a low modulation voltage, a small insertion loss, good linearity, small power consumption, a small size, and the like. In addition, the electro-optic modulator is required to be easily integrated.

However, a current electro-optic modulator has low modulation efficiency and a complex process, and cannot be easily integrated. Consequently, a usage scenario of the electro-optic modulator is limited.

### SUMMARY

In view of this, this application provides an electro-optic modulator, a manufacturing method thereof, and an optical communication system, to obtain a device with high performance and wide applicability.

To resolve the foregoing technical problem, the following technical solutions are used in this application.

A first aspect of this application provides an electro-optic modulator, including a substrate and a dielectric layer located on a side of the substrate. An organic waveguide and electrodes on two sides of the organic waveguide are disposed in the dielectric layer, a refractive index of the organic waveguide is greater than a refractive index of the dielectric layer, and a material of the organic waveguide is an organic material having electro-optic effect. Generally, the material of the organic waveguide is incompatible with a CMOS process. Therefore, the electrodes may be disposed on the two sides of the organic waveguide, and the organic waveguide may be disposed in the dielectric layer. In this way, the organic waveguide may be formed after another CMOS process is completed. Therefore, it may be considered that the organic waveguide is compatible with the another CMOS process. This facilitates chip integration and can be applied to a wider range. In addition, the organic waveguide has a wide operating wavelength range, high linear electro-optic effect, and high modulation efficiency. That is, the electro-optic modulator has high electro-optic modulation efficiency, is conducive to integration, and has higher performance and a wider application scope.

In some possible implementations, a dielectric waveguide is disposed in the organic waveguide, the dielectric waveguide and the organic waveguide form a composite waveguide, and a refractive index of the dielectric waveguide is greater than the refractive index of the organic waveguide.

In this embodiment of this application, the dielectric waveguide is disposed in the organic waveguide, and the dielectric waveguide may be better compatible with the CMOS process. In addition, the dielectric waveguide may limit an optical mode, so that the composite waveguide has a stronger light field limiting capability: This helps improve device performance.

In some possible implementations, a material of the dielectric waveguide is one of the following: silicon nitride, hydrogenated amorphous silicon, or titanium dioxide.

In this embodiment of this application, the material of the dielectric waveguide may be a material that has good light transmission and whose refractive index is greater than the refractive index of the organic waveguide. This helps improve the device performance.

In some possible implementations, the dielectric waveguide has a width range of 50 nanometers to 300 nanometers and a height range of 150 nanometers to 500 nanometers.

In this embodiment of this application, the dielectric waveguide may be small in size to limit the optical mode, and is insufficient to limit the optical mode in the dielectric waveguide, so that an optical signal is transmitted in the dielectric waveguide and the organic waveguide. This helps improve modulation efficiency of the composite waveguide.

In some possible implementations, the electro-optic modulator further includes:
a transmission waveguide in the dielectric layer, where a refractive index of the transmission waveguide is greater than the refractive index of the dielectric layer, and the transmission waveguide is connected to an input end and/or an output end of the composite waveguide.

In this embodiment of this application, the electro-optic modulator may further include the transmission waveguide that is configured to: transmit an optical signal to the composite waveguide, and transmit a signal in the composite waveguide to another component. This facilitates a personalized design of a device.

In some possible implementations, a material of the transmission waveguide is consistent with the material of the dielectric waveguide, the transmission waveguide is connected to the dielectric waveguide, and a width of the transmission waveguide is greater than a width of the dielectric waveguide.

In this embodiment of this application, the material of the transmission waveguide may be consistent with the material of the dielectric waveguide, the transmission waveguide may be connected to the dielectric waveguide, and the transmission waveguide and the dielectric waveguide may be formed by using a same process. In addition, efficiency of coupling between the same material is high.

In some possible implementations, the transmission waveguide has a width range of 400 nanometers to 1000 nanometers and a height range of 150 nanometers to 500 nanometers.

In this embodiment of this application, the transmission waveguide may be used as an independent waveguide, and the width of the transmission waveguide is greater than the width of the dielectric waveguide. This facilitates optical signal transmission.

In some possible implementations, the electro-optic modulator further includes:
a coupling structure, where the coupling structure is connected to the transmission waveguide and the composite waveguide.

In this embodiment of this application, the electro-optic modulator further includes the coupling structure that is configured to be connected to the transmission waveguide and the composite waveguide, to improve efficiency of coupling between the transmission waveguide and the composite waveguide.

In some possible implementations, the coupling structure is located in the organic waveguide, and is connected to the dielectric waveguide and the transmission waveguide, and widths of the coupling structure gradually increase from an end connected to the dielectric waveguide to an end connected to the transmission waveguide.

In this embodiment of this application, the coupling structure may be located in the organic waveguide, and may be connected to the dielectric waveguide and the transmission waveguide. In addition, the widths of the coupling structure gradually increase from the dielectric waveguide to the transmission waveguide, so that high efficiency of coupling between the transmission waveguide and the composite waveguide can be implemented.

In some possible implementations, a material of the coupling structure is consistent with the material of the dielectric waveguide.

In this embodiment of this application, if the material of the coupling structure is consistent with the material of the dielectric waveguide, the coupling structure and the dielectric waveguide can be formed by using a same process, and efficiency of optical coupling between the same material is high.

In some possible implementations, the coupling structure has a length range of 5 micrometers to 100 micrometers.

In some possible implementations, the coupling structure needs to have an appropriate length, to avoid a problem of low coupling efficiency caused by a sudden change in waveguide performance caused by an excessively short coupling structure, and to avoid a problem of an excessively large device structure caused by an excessively long coupling structure.

In some possible implementations, the electro-optic modulator further includes:
a first optical splitter whose output ends are connected to input ends of two composite waveguides, and a second optical splitter whose input ends are connected to output ends of the two composite waveguides, where the first optical splitter and the second optical splitter are located in the dielectric layer, and a refractive index of the first optical splitter and a refractive index of the second optical splitter are greater than the refractive index of the dielectric layer.

In this embodiment of this application, the electro-optic modulator may further include the first optical splitter and the second optical splitter. The first optical splitter, the second optical splitter, and the two composite waveguides may form an MZ interferometer, so that the MZ interferometer has high modulation efficiency.

In some possible implementations, a material of the first optical splitter and a material of the second optical splitter are consistent with the material of the dielectric waveguide, and a width of the output end of the first optical splitter and a width of the input end of the second optical splitter are greater than the width of the dielectric waveguide.

In this embodiment of this application, the first optical splitter and the second optical splitter may be disposed in the dielectric layer, and the material of the first optical splitter and the material of the second optical splitter may be consistent with the material of the dielectric waveguide. In this way, the first optical splitter, the second optical splitter, and the dielectric waveguide may be formed by using a same process, and efficiency of coupling between the same material is high.

In some possible implementations, the organic waveguide has a width range of 500 nanometers to 2000 nanometers and a height range of 500 nanometers to 2000 nanometers.

In this embodiment of this application, a width and a height of the organic waveguide are greater than the width and a height of the dielectric waveguide. In this way, the organic waveguide completely surrounds the dielectric waveguide. In a case in which the dielectric waveguide is insufficient to limit the optical mode in the dielectric waveguide, the optical signal is diffused into the organic waveguide, and the organic waveguide and the dielectric waveguide jointly form the composite waveguide to transmit the optical signal.

In some possible implementations, a material of the electrodes is at least one of the following: aluminum, copper, or tungsten.

In this embodiment of this application, the material of the electrodes may be a material having good electrical conductivity. This helps improve the device performance.

In some possible implementations, a spacing between the electrodes on the two sides of the organic waveguide is 2 micrometers to 6 micrometers.

In this embodiment of this application, the composite waveguide has good modulation efficiency. This helps expand the spacing between the electrodes on the two sides of the organic waveguide, reduces light absorption by the electrodes, and reduces an insertion loss of the electrodes.

In some possible implementations, a material of the dielectric layer is silicon oxide.

In this embodiment of this application, the material of the dielectric layer may be silicon oxide, the refractive index of the dielectric layer is less than the refractive index of the dielectric waveguide and is also less than the refractive index of the organic waveguide, and the dielectric waveguide and the organic waveguide can be protected.

In some possible implementations, the electro-optic modulator further includes:
a sealing layer covering the organic waveguide.

In this embodiment of this application, the electro-optic modulator may further include the sealing layer covering the organic waveguide. The sealing layer can protect the organic waveguide, and can also prevent an organic material leakage before the organic waveguide is cured.

A second aspect of this application provides a manufacturing method of an electro-optic modulator, including:
providing a substrate;
forming a dielectric layer on the substrate;
etching the dielectric layer to obtain electrode holes, and forming electrodes in the electrode holes; and
etching the dielectric layer to obtain a waveguide window; and filling the waveguide window with an organic material to form an organic waveguide, where the electrode holes are located on two sides of the waveguide window, a refractive index of the organic waveguide is greater than a refractive index of the dielectric layer, and a material of the organic waveguide is an organic material having electro-optic effect.

In some possible implementations, a dielectric waveguide is disposed in the organic waveguide, the dielectric waveguide and the organic waveguide form a composite waveguide, the dielectric layer includes a first dielectric layer and a second dielectric layer, and the forming a dielectric layer on the substrate includes:
forming the first dielectric layer on the substrate;
forming a dielectric material layer on the first dielectric layer;
etching the dielectric material layer to obtain the dielectric waveguide, where a refractive index of the dielectric waveguide is greater than the refractive index of the organic waveguide, and the waveguide window exposes an upper surface and a side wall of the dielectric waveguide; and
forming, on the first dielectric layer, the second dielectric layer covering the dielectric waveguide.

In some possible implementations, a material of the dielectric waveguide is one of the following: silicon nitride, hydrogenated amorphous silicon, or titanium dioxide.

In some possible implementations, the dielectric waveguide has a width range of 50 nanometers to 300 nanometers and a height range of 150 nanometers to 500 nanometers.

In some possible implementations, the method further includes:
etching the dielectric material layer to obtain a transmission waveguide, where the transmission waveguide is connected to an input end and/or an output end of the composite waveguide, and a width of the transmission waveguide is greater than a width of the dielectric waveguide.

In some possible implementations, the transmission waveguide has a width range of 400 nanometers to 1000 nanometers and a height range of 150 nanometers to 500 nanometers.

In some possible implementations, the method further includes:
etching the dielectric material layer to obtain a coupling structure, where the coupling structure is connected to the transmission waveguide and the dielectric waveguide, widths of the coupling structure gradually increase from an end connected to the dielectric waveguide to an end connected to the transmission waveguide, and the waveguide window exposes an upper surface and a side wall of the coupling structure.

In some possible implementations, the coupling structure has a length range of 5 micrometers to 100 micrometers.

In some possible implementations, the method further includes:
etching the dielectric material layer to obtain a first optical splitter and a second optical splitter, where an output end of the first optical splitter is connected to input ends of two dielectric waveguides, an input end of the second optical splitter is connected to output ends of the two dielectric waveguides, and a width of the output end of the first optical splitter and a width of the input end of the second optical splitter are greater than the width of the dielectric waveguide.

In some possible implementations, the organic waveguide has a width range of 500 nanometers to 2000 nanometers and a height range of 500 nanometers to 2000 nanometers.

In some possible implementations, a material of the electrodes is at least one of the following: aluminum, copper, or tungsten.

In some possible implementations, a spacing between the electrodes on the two sides of the organic waveguide is 2 micrometers to 6 micrometers.

In some possible implementations, a material of the dielectric layer is silicon oxide.

In some possible implementations, after the filling the waveguide window with an organic material, the method further includes:
forming a sealing layer on the organic material: and
polarizing the organic material to obtain the organic waveguide.

A third aspect of this application provides an optical communication system, including a laser, a photodetector, and the electro-optic modulator provided in the first aspect of this application. The electro-optic modulator is disposed between the laser and the photodetector, the laser is configured to transmit an optical signal, the electro-optic modulator is configured to perform electro-optic modulation on the optical signal, and the photodetector is configured to detect an optical signal obtained through the electro-optic modulation.

It can be learned from the foregoing technical solutions that embodiments of this application have the following advantages.

Embodiments of this application provide an electro-optic modulator, a manufacturing method thereof, and an optical communication system. The electro-optic modulator includes a substrate and a dielectric layer located on a side of the substrate. An organic waveguide and electrodes on two sides of the organic waveguide are disposed in the dielectric layer, a refractive index of the organic waveguide is greater than a refractive index of the dielectric layer, and a material of the organic waveguide is an organic material having electro-optic effect. Generally, the material of the organic waveguide is incompatible with a CMOS process. Therefore, the electrodes may be disposed on the two sides of the organic waveguide, and the organic waveguide may be disposed in the dielectric layer. In this way, the organic waveguide may be formed after another CMOS process is completed. Therefore, it may be considered that the organic waveguide is compatible with the another CMOS process. This facilitates chip integration and can be applied to a wider range. In addition, the organic waveguide has a wide operating wavelength range, high linear electro-optic effect, and high modulation efficiency. That is, the electro-optic modulator has high electro-optic modulation efficiency, is conducive to integration, and has higher performance and a wider application scope.

### BRIEF DESCRIPTION OF DRAWINGS

To clearly understand specific implementations of this application, the following briefly describes accompanying drawings used for describing the specific implementations of this application. It is clear that the accompanying drawings show merely some embodiments of this application.

FIG. 1 is a schematic diagram of a structure of an electro-optic modulator according to an embodiment of this application:

FIG. 2 is a sectional view of the electro-optic modulator shown in FIG. 1 in an AA direction:

FIG. 3 is a schematic diagram of a structure of another electro-optic modulator according to an embodiment of this application:

FIG. 4 is a sectional view of the electro-optic modulator shown in FIG. 3 in an AA direction:

FIG. 5 is a schematic diagram of a structure of still another electro-optic modulator according to an embodiment of this application:

FIG. 6 is a schematic diagram of a structure of still another electro-optic modulator according to an embodiment of this application:

FIG. 7 is a schematic diagram of electric field distribution after a 1 V voltage is applied to electrodes according to an embodiment of this application:

FIG. 8 is a schematic diagram of simulation verification of a composite lightguide according to an embodiment of this application:

FIG. 9 is a schematic diagram of a structure of still another electro-optic modulator according to an embodiment of this application:

FIG. 10 is a schematic diagram of light field distribution in a coupling region according to an embodiment of this application:

FIG. 11 is a schematic diagram of a structure of still another electro-optic modulator according to an embodiment of this application:

FIG. 12 is a flowchart of a manufacturing method of an electro-optic modulator according to an embodiment of this application: and

FIG. 13 to FIG. 24 are schematic diagrams of structures of an electro-optic modulator in a manufacturing process.

### DESCRIPTION OF EMBODIMENTS

Embodiments of this application provide an electro-optic modulator, a manufacturing method thereof, and an optical communication system, to obtain a device with high performance and wide applicability.

In the specification, claims, and accompanying drawings of this application, the terms “first”, “second”, “third”, “fourth”, and the like (if exist) are intended to distinguish between similar objects but do not necessarily indicate a specific order or sequence. It should be understood that the data termed in such a way are interchangeable in proper circumstances so that embodiments described herein can be implemented in other orders than the order illustrated or described herein. In addition, the terms “include” and “contain” and any other variants mean to cover the non-exclusive inclusion. For example, a process, method, system, product, or device that includes a series of steps or units is not necessarily limited to those expressly listed steps or units, but may include other steps or units not expressly listed or inherent to such a process, method, product, or device.

This application is described in detail with reference to the schematic diagram, When embodiments of this application are described in detail, for ease of description, a sectional view of a device structure is partially enlarged not according to a general proportion, and the schematic diagram is merely an example, and should not limit the protection scope of this application. In addition, a length, a width, and a depth of three-dimensional space should be included in actual production.

Currently, as an important device in an optical communication system, an electro-optic modulator has received wide attention. Specifically, the electro-optic modulator includes a dielectric material in an electric field. The dielectric material is used as a waveguide, and a refractive index of the dielectric material changes under an action of the electric field. Therefore, a phase of light passing through the dielectric material is changed, and an electrical signal is loaded onto light transmitted in the waveguide. The electro-optic modulator may be implemented based on free-carrier dispersion (FCD) effect of silicon, or may be implemented based on linear electro-optic effect (or Pockels effect).

Specifically, in a silicon photonic integrated circuit (silicon PIC), light modulation is generally implemented by using FCD of silicon. However, because carrier dispersion effect changes a refractive index and a light absorption coefficient of the silicon, a crystal structure of a silicon material has center inversion symmetry, cannot generate a second-order nonlinear phenomenon, and does not have linear electro-optic effect. Therefore, only FCD effect of the silicon material can be used. The FCD effect changes a carrier distribution concentration in a silicon waveguide to change the refractive index of the silicon. In this way, a phase of an optical signal is changed, and the electrical signal is converted into the optical signal. However, a carrier movement rate in the silicon material limits a modulation bandwidth, and a theoretical maximum modulation bandwidth of a silicon modulator is only approximately 60 GHZ. In addition, changing the carrier concentration changes the refractive index of the silicon, and also changes light absorption. This causes a low extinction ratio of a modulated optical signal. In addition, because the FCD effect is a non-linear process, linearity of modulation is poor, and is far less than linearity of another electro-optic modulator based on the linear electro-optic effect. In addition, a band on which the silicon is transparent limits an operating wavelength of the modulator, so that the operating wavelength of the modulator is on a band greater than 1.1 micrometers, and a range is small.

The linear electro-optic effect is widely considered as a physical mechanism that is very suitable for implementing high-bandwidth electro-optic modulation. The operating principle of the effect is that a refractive index of the crystal changes due to an external electric field, and a change amount is directly proportional to electric field strength. A high-efficiency and high-speed integrated electro-optic modulator based on the linear electro-optic effect has received wide attention in recent years. An electro-optic polymer (EO polymer) material has very high linear electro-optic effect, and a Pockels coefficient of the material is generally much greater than a Pockels coefficient of an inorganic electro-optic crystal (for example, lithium niobate, or the like). Therefore, an organic-material electro-optic modulator (silicon-organic hybrid modulator. SOH, or silicon-polymer hybrid modulator, SPH) with high-performance and ultra-compact size may be produced by using the electro-optic polymer material. However, the EO polymer material is not a material compatible with a complementary metal-oxide-semiconductor (CMOS) process. After these materials are deposited on a wafer, the materials cannot be diced on a conventional wafer dicing platform. Consequently, a modulator based on the electro-optic polymer material has difficulty in being integrated with another silicon photonic device, and cannot be integrated with another photonic layer, that is, multilayer photonics integration cannot be implemented. Scalability is poor. Consequently, a usage scenario of the electro-optic modulator is limited.

Based on the foregoing technical problem, embodiments of this application provide an electro-optic modulator, a manufacturing method thereof, and an optical communication system. The electro-optic modulator includes a substrate and a dielectric layer located on a side of the substrate. An organic waveguide and electrodes on two sides of the organic waveguide are disposed in the dielectric layer, a refractive index of the organic waveguide is greater than a refractive index of the dielectric layer, and a material of the organic waveguide is an organic material having electro-optic effect. Generally, the material of the organic waveguide is incompatible with a CMOS process. Therefore, the electrodes may be disposed on the two sides of the organic waveguide, and the organic waveguide may be disposed in the dielectric layer. In this way, the organic waveguide may be formed after another CMOS process is completed. Therefore, it may be considered that the organic waveguide is compatible with the another CMOS process. This facilitates chip integration and can be applied to a wider range. In addition, the organic waveguide has a wide operating wavelength range, high linear electro-optic effect, and high modulation efficiency. That is, the electro-optic modulator has high electro-optic modulation efficiency, is conducive to integration, and has higher performance and a wider application scope.

To make the objectives, features, and advantages of this application more apparent and understandable, the following describes specific implementations of this application in detail with reference to the accompanying drawings.

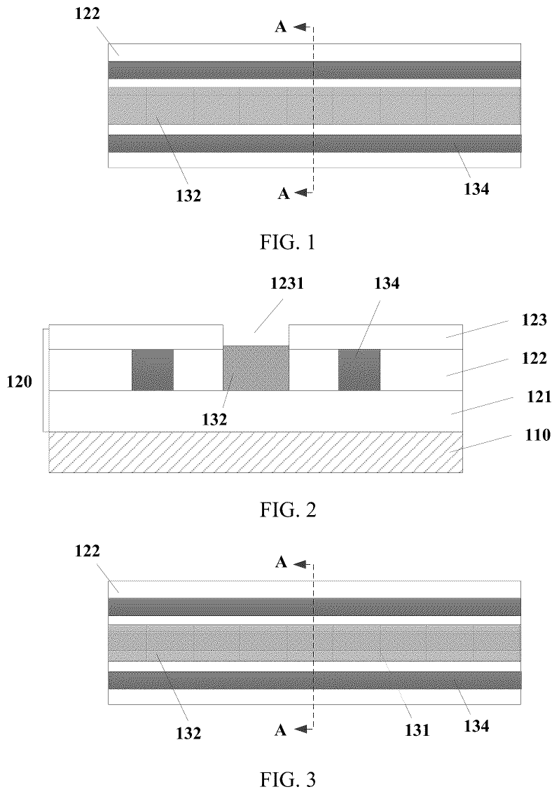

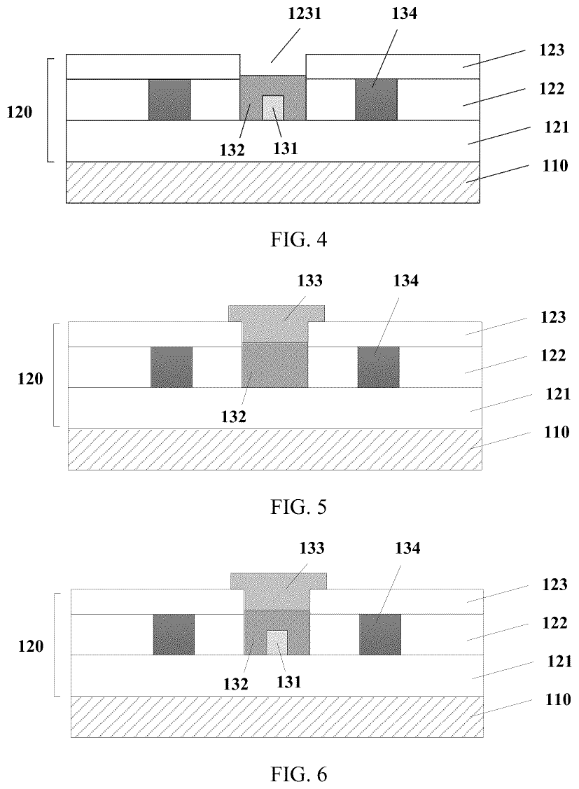

FIG. 1 to FIG. 6 are schematic diagrams of structures of an electro-optic modulator according to an embodiment of this application. FIG. 2 is a sectional view of the electro-optic modulator shown in FIG. 1 in an AA direction. FIG. 4 is a sectional view of the electro-optic modulator shown in FIG. 3 in an AA direction. The electro-optic modulator may include a substrate 110 and a dielectric layer 120 located on a side of the substrate 110. An organic waveguide 132 and electrodes 134 on two sides of the organic waveguide 132 are disposed in the dielectric layer 120.

In this embodiment of this application, the substrate 110 may be an insulator substrate, or may be a semiconductor substrate, for example, may be a silicon oxide substrate, a silicon substrate, a germanium substrate, a silicon-germanium substrate, a silicon-on-insulator (SOI) substrate, a germanium-on-insulator (GOI) substrate, or the like. The substrate 110 may provide specific support for a device. At least one photonic layer (not shown in the figure) may be disposed on a side of the substrate 110. The photonic layer is configured to implement a special electronic-photonic function, and the dielectric layer 120 may be disposed on a side that is of the photonic layer and that is away from the substrate 110, to implement integration of a plurality of kinds of functional layers. For ease of description, a surface of a side on which another film layer is disposed on the substrate 110 may be used as an upper surface, the another film layer is, for example, the dielectric layer 120, the photonic layer, or the like, and the substrate 110 is used as a support structure of the another film layer on the substrate 110.

The dielectric layer 120 may be disposed on a side of the substrate 110, and the organic waveguide 132 is disposed in the dielectric layer 120. The organic waveguide 132 has an extension direction, and the extension direction is a propagation direction of an optical signal. Refer to FIG. 1 and FIG. 3. The extension direction of the organic waveguide 132 is a horizontal direction. Refer to FIG. 2, FIG. 4, FIG. 5, and FIG. 6. The extension direction of the organic waveguide 132 is a direction perpendicular to a paper surface. For ease of description, a direction parallel to a surface of the substrate 110 is used as a horizontal direction, and a direction perpendicular to the surface of the substrate 110 is used as a longitudinal direction. A size that is of structures such as the organic waveguide 132, a dielectric waveguide 131, and a coupling structure 139, or the like and that is perpendicular to the surface of the substrate 110 is defined as a “height” or “thickness”. A size parallel to the surface of the substrate 110 and perpendicular to the extension direction of the organic waveguide 132 is defined as a “width”. A size parallel to the surface of the substrate 110 and parallel to the extension direction of the organic waveguide 132 is defined as a “length”.

Specifically, if a refractive index of the organic waveguide 132 is greater than a refractive index of the dielectric layer 120, the organic waveguide 132 is used as a waveguide core, and the dielectric layer 120 is used as a waveguide cladding. A light field may be limited in the organic waveguide 132 by using a principle of total internal reflection. A material of the dielectric layer 120 may be silicon oxide. A material of the organic waveguide 132 is an organic material having electro-optic effect, and has a feature of high modulation efficiency. The organic waveguide 132 can generate an obvious refractive index change in an electric field, and the change may change a transmission feature of the optical signal, for example, change a phase of the optical signal, to implement modulation. Across section of the organic waveguide 132 may be a rectangle or a trapezoid. The organic waveguide 132 has a height range of 500 nanometers to 2000 nanometers (nm) and a width range of 500 nanometers to 2000 nanometers, so that the organic waveguide 132 is controlled to be in a single-mode state. This facilitates propagation and control of the optical signal. A thickness of the dielectric layer 120 may be greater than a height of the organic waveguide 132, or may be equal to a height of the organic waveguide 132.

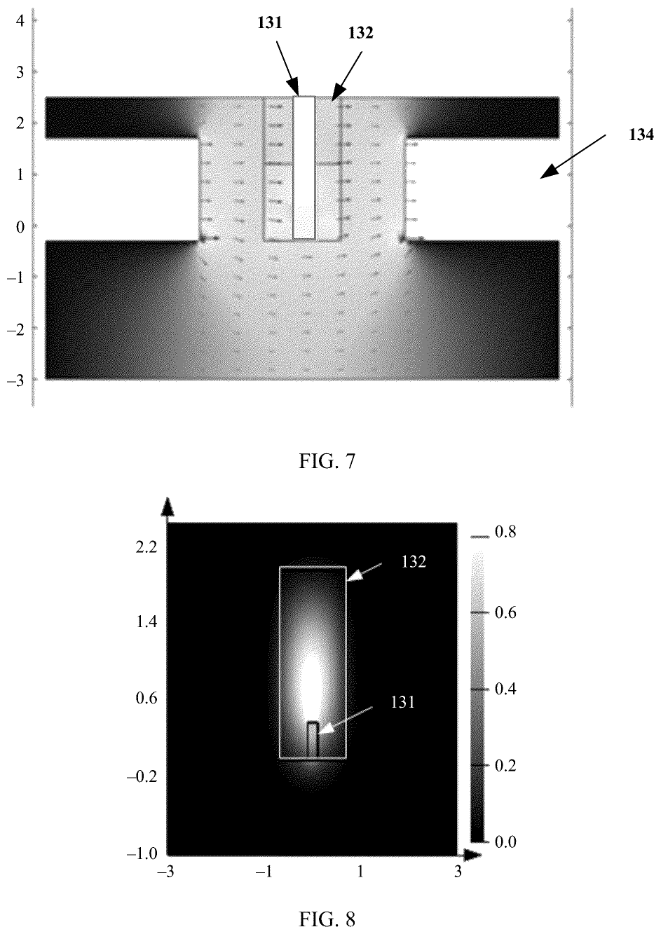

The electrodes 134 on the two sides of the organic waveguide 132 are further disposed in the dielectric layer 120. Extension directions of the electrodes 134 are consistent with the extension direction of the organic waveguide 132. When a voltage is applied, the electrodes 134 may provide an electric field perpendicular to a transmission direction of the optical signal, to change the refractive index of the organic waveguide 132, and to adjust a feature of the optical signal in the organic waveguide 132. There are at least two electrodes 134. Different potentials are applied to the electrodes 134 located on different sides of the organic waveguide 132, to generate the electric field. FIG. 7 is a schematic diagram of electric field distribution after a 1 V voltage is applied to the electrodes according to an embodiment of this application. A horizontal coordinate and a vertical coordinate of the diagram indicate a location, and a direction of the electric field generated by the electrodes 134 is perpendicular to the extension direction of the organic waveguide 132. The electrodes 134 have good electrical conductivity, and may be metal electrodes. Specifically, a material of the electrodes 134 may be at least one of the following: copper, aluminum, tungsten, and the like, or may be, for example, aluminum. Surfaces (upper surfaces) of a side that is of the electrodes 134 and that is away from the substrate 110 may be flush with the dielectric layer 120, so that lead-out structures of the electrodes 134 are conveniently disposed. Surfaces of a side that is of the electrodes 134 and that is away from the substrate 110 may alternatively be lower than a surface of a side that is of the dielectric layer 120 and that is away from the substrate 110, and may be exposed, so that lead-out structures of the electrodes 134 are disposed on the side that is of the electrodes 134 and that is away from the substrate 110. Certainly, interconnection structures may be further disposed on the side that is of the electrodes 134 and that is away from the substrate 110, so that the electrodes 134 are connected to the lead-out structures. This is not illustrated herein and is not described by using an example.

Generally, the electrodes 134 made of metal absorb light. Therefore, distances between the electrodes 134 and the organic waveguide 132 cannot be too short. Otherwise, a serious optical loss is caused. However, if a distance between the electrodes 134 is too long, the electric field between the electrodes 134 is weak under the same voltage. This affects modulation efficiency. Therefore, horizontal distances between the electrodes 134 and the organic waveguide 132 may be determined based on requirements for an optical signal loss and the modulation efficiency. The distance between the two electrodes 134 located on the two sides of the organic waveguide 132 is greater than a width of the organic waveguide 132, and a distance range of the two electrodes 134 is 2 micrometers to 6 micrometers (μm). The electrodes 134 and the organic waveguide 132 may be in direct contact, or may be separated by using the dielectric layer 120. In this embodiment of this application, a size of the dielectric waveguide, a size of the organic waveguide 132, and the distance between the electrodes 134 are optimized, so that the modulation efficiency and an insertion loss of the electro-optic modulator can be optimized.

The electrodes 134 are disposed on the two sides of the organic waveguide 132, and the electrodes 134 and the organic waveguide 132 are both disposed in the dielectric layer 120. Therefore, in manufacturing the electro-optic modulator, the dielectric layer 120 and the electrodes 134 may be first formed, and then the organic waveguide 132 is formed through filling. That is, the organic waveguide 132 may be formed in a last step, and a manufacturing process does not need a process such as silicon doping or the like. Therefore, a process may be considered to be compatible with a CMOS back-end-of-line process, certainly may also be compatible with another silicon photonic device or CMOS device, and is suitable for multilayer photonics integration. That is, device integration has better scalability, and the process is suitable for a three-dimensional (3D) electro-optic integrated circuit with multiple photonic layers. Compared with a silicon waveguide, the organic waveguide 132 has a wider operating wavelength range, is suitable for an infrared band/a near-infrared band, and is suitable for a visible light band. In addition, the organic waveguide 132 has a wide operating wavelength range and high linear electro-optic effect. Therefore, the modulation efficiency is high. In this way, the electro-optic modulator has high electro-optic modulation efficiency, is conducive to integration, and has higher performance and a wider application scope.

In this embodiment of this application, through filling with the organic material and polarizing the organic material, the organic waveguide 132 may be formed. A sealing layer 133 may be further formed on a side that is of the organic waveguide 132 and that is away from the substrate 110. Refer to FIG. 5 and FIG. 6. The sealing layer 133 covers the organic waveguide 132, and is configured to: protect the organic waveguide 132 and prevent an organic material leakage in a forming process of the organic waveguide 132. A material of the sealing layer 133 may be paraffin. The sealing layer 133 may cover only the organic waveguide 132, or may cover both the organic waveguide 132 and the dielectric layer 120.

In this embodiment of this application, the dielectric waveguide (deposited dielectric waveguide) 131 may be further disposed in the organic waveguide 132. Refer to FIG. 3, FIG. 4, and FIG. 6. A refractive index of the dielectric waveguide 131 is greater than the refractive index of the organic waveguide 132. In other words, a waveguide in this embodiment of this application may be a composite waveguide including the dielectric waveguide 131 and the organic waveguide 132. The dielectric waveguide 131 may limit an optical mode. Therefore, compared with the organic waveguides in FIG. 1, FIG. 2, and FIG. 5, the composite waveguide has a stronger light field limiting capability, so that an optical mode field area is smaller, light absorption by the electrodes 134 is reduced, and this helps achieve a shorter distance between the electrodes 134 without increasing light absorption intensity. Therefore, under a same voltage condition, this enhances horizontal electric field strength, improves overlap efficiency of the electric field and the light field, and improves modulation efficiency of a phase shifter. A shorter modulation region length may be designed to implement an optical signal phase change required for modulation, and to reduce a limitation on a modulation bandwidth. In addition, this helps reduce a size of the phase shifter. The dielectric waveguide 131 may be transparent on the visible light band, so that an operating wavelength of the electro-optic modulator may expand from infrared/near-infrared to visible light. The dielectric waveguide 131 may have a small size, and is insufficient to limit the optical mode in the dielectric waveguide 131. However, existence of the organic waveguide 132 limits the optical mode in the organic waveguide 132. Specifically, a material of the dielectric waveguide 131 may be a dielectric material, for example, may be one of the following: silicon nitride (SiN), hydrogenated amorphous silicon (a-Si:H), titanium dioxide (TiO₂), and the like.

It should be noted that the dielectric waveguide 131 may not have the electro-optic effect. Therefore, a larger size of the dielectric waveguide 131 indicates poorer modulation effect on the optical signal, and a smaller size of the dielectric waveguide 131 indicates smaller limiting effect on the optical mode. Therefore, the size of the dielectric waveguide 131 may be appropriately adjusted to balance modulation effect and limiting effect on the optical mode. The dielectric waveguide 131 is disposed in the organic waveguide 132, and the size of the dielectric waveguide 131 is less than the size of the organic waveguide 132. The dielectric waveguide 131 may have a width range of 50 nanometers to 300 nanometers and a height range of 150 nanometers to 500 nanometers. Widths of the dielectric waveguide 131 located in the same organic waveguide 132 may be uniform widths, or may be non-uniform widths. That is, widths of different locations of the dielectric waveguide 131 may be consistent, or may be inconsistent. In a case in which the widths of the dielectric waveguide 131 are inconsistent, a minimum width is greater than or equal to 50 nanometers, and a maximum width is less than or equal to 300 nanometers.

FIG. 8 is a schematic diagram of simulation verification of a composite lightguide according to an embodiment of this application. The simulation operating is based on a two-dimensional finite element method (FEM). A horizontal coordinate and a vertical coordinate of the diagram indicate a location, and different colors represent different light brightness. Under a simulation condition, a central white region is a region in which the light field is located. It can be learned from the figure that the light field is mostly distributed in the organic waveguide 132, a small part is distributed in the dielectric waveguide 131, and the light field seldom leaks to a periphery of the organic waveguide 132. The operating wavelength of the electro-optic modulator is 1550 nanometers, the material of the dielectric waveguide 131 is SiN, the refractive index of the dielectric waveguide 131 is 1.98, and a dielectric constant is 7.9; a refractive index of an EO polymer is 1.70, a dielectric constant is 2.49, and a Pockels coefficient is 300 pm/V; the material of the dielectric layer 120 is SiO₂, a refractive index of SiO₂ is 1.44, and a dielectric constant is 3.9; the material of the sealing layer 133 is paraffin, a refractive index of the paraffin is 1.4, and a dielectric constant is 2.2; and the material of the electrodes 134 is aluminum, and a refractive index is 1.44+16i. In a case in which a SiN waveguide core has a height of 400 nanometers and a width of 200 nanometers, and the EO polymer has a width of 1.5 micrometers and a height of 1.5 micrometers, an effective refractive index of the composite waveguide is 1.62, a spacing between the aluminum electrodes 134 is 4 micrometers, modulation efficiency V_{π}L of the electro-optic modulator is 4.3 V·mm, and a waveguide transmission loss (metal-induced loss) caused by the metal electrodes is 0.3 dB/cm. A value of the V_{π}L means a product of a length L of a modulation region and a value of a voltage V_{π} that needs to be applied to two ends of the electrodes 134 when a light phase change with a value of π is implemented in the waveguide. Therefore, a smaller value of the V_{π}L indicates higher modulation efficiency.

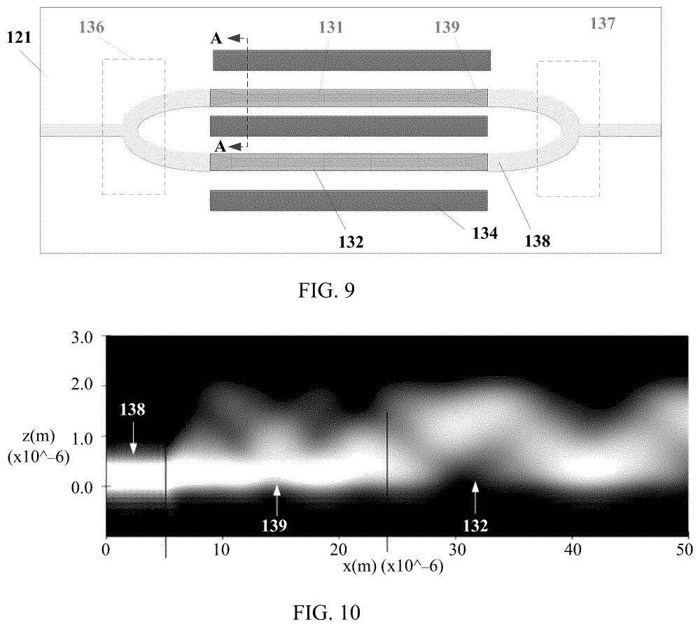

In this embodiment of this application, a region in which the organic waveguide 132 is located is the modulation region, where the electrodes 134 are disposed on the two sides of the organic waveguide 132. Another waveguide may be further disposed outside the modulation region, and is configured to transmit an optical signal without modulating the optical signal. That is, the electro-optic modulator in this embodiment of this application may further include a transmission waveguide 138. FIG. 9 is a schematic diagram of a structure of an electro-optic modulator according to an embodiment of this application. For a sectional view of FIG. 9 in an AA direction, refer to FIG. 4. The transmission waveguide 138 may be a single-mode waveguide. The transmission waveguide 138 may be disposed in the dielectric layer 120. A refractive index of the transmission waveguide 138 is greater than the refractive index of the dielectric layer 120. The dielectric layer 120 is used as a cladding of the transmission waveguide 138. The transmission waveguide 138 may be connected to an input end and/or an output end of the organic waveguide 132 or the composite waveguide. In a case in which the dielectric waveguide 131 is not disposed in the organic waveguide 132, the transmission waveguide 138 and the organic waveguide 132 may be connected to each other, may be made of different materials, and may have different widths. Certainly, coupling efficiency is high when the widths are the same.

For ease of manufacturing, a material of the transmission waveguide 138 may be consistent with the material of the dielectric waveguide 131, and the transmission waveguide 138 and the dielectric waveguide 131 may be formed simultaneously, and may have a same height and different widths. In this case, the transmission waveguide 138 may be connected to the dielectric waveguide 131. Specifically, a width of the transmission waveguide 138 may be greater than a width of the dielectric waveguide 131. The width of the transmission waveguide 138 may be less than the width of the organic waveguide 132, to reduce an optical loss in a transmission process. For example, the transmission waveguide 138 may have a height range of 150 nanometers to 500 nanometers and a width range of 400 nanometers to 1000 nanometers.

In this embodiment of this application, the electro-optic modulator may further include the coupling structure 139. Refer to FIG. 9. The coupling structure 139 may be disposed between the transmission waveguide 138 and the organic waveguide 132, or between the transmission waveguide 138 and the composite waveguide, to improve efficiency of coupling between the transmission waveguide 138 and the organic waveguide 132 or between the transmission waveguide 138 and the composite waveguide. In a case in which the dielectric waveguide 131 is disposed in the organic waveguide 132, the coupling structure 139 may be disposed in the organic waveguide 132, and may be connected to the transmission waveguide 138 and the dielectric waveguide 131. In addition, widths of the coupling structure 139 gradually increase from the dielectric waveguide 131 to the transmission waveguide 138, and a refractive index of the coupling structure 139 is greater than the refractive index of the organic waveguide 132.

For ease of manufacturing, a material of the coupling structure 139 may be inconsistent with the material of the dielectric waveguide 131, or may be consistent with the material of the dielectric waveguide 131. In addition, in a case in which the material of the coupling structure 139 is consistent with the material of the dielectric waveguide 131, the coupling structure 139 and the dielectric waveguide 131 may be formed simultaneously and may have a same height. In other words, the transmission waveguide 138, the coupling structure 139, and the dielectric waveguide 131 may be made of a same material and have a same height, a width of an end that is of the coupling structure 139 and that is connected to the transmission waveguide 138 may be consistent with the width of the transmission waveguide 138, and a width of an end that is of the coupling structure 139 and that is connected to the dielectric waveguide 131 may be consistent with the width of the dielectric waveguide 131. The coupling structure 139 has a length range of 5 micrometers to 100 micrometers.

The coupling structure 139 is connected to the transmission waveguide 138, and is connected to the dielectric waveguide 131. In a case in which the coupling structure 139, the transmission waveguide 138, and the dielectric waveguide 131 are made of a same material, there may be no obvious distinguishing boundary. That is, the coupling structure 139, the transmission waveguide 138, and the dielectric waveguide 131 may be an integrated structure made of a same type of dielectric material. A difference between the coupling structure 139 and the transmission waveguide 138 lies in that the coupling structure 139 is located in the organic waveguide 132, and a difference between the coupling structure 139 and the dielectric waveguide 131 lies in that the dielectric waveguide 131 has a small size and may limit the optical mode. Therefore, a part that is of the dielectric material of the integrated structure and that is located outside the organic waveguide 132 may be used as the transmission waveguide, a part that is surrounded by the organic waveguide 132, that is located in a middle of the composite waveguide, and whose width is in a first range may be used as the dielectric waveguide 131, and a part that is located at two ends of the composite waveguide and whose width is greater than the width of the dielectric waveguide and is less than the width of the organic waveguide may be used as the coupling structure 139, where the first range may be 50 nanometers to 300 nanometers.

For example, in a case in which materials of the transmission waveguide 138, the coupling structure 139, and the dielectric waveguide 131 are SiN, the width of the transmission waveguide 138 is 1 micrometer, the width of the organic waveguide 132 is 0.4 micrometer, and a length of the coupling structure 139 is 20 micrometers, the efficiency of coupling between the transmission waveguide 138 and the composite waveguide is approximately 98%. FIG. 10 is a schematic diagram of light field distribution in a coupling region according to an embodiment of this application. A horizontal coordinate and a vertical coordinate of the diagram indicate a location, and different colors represent different light brightness. Under a simulation condition, a central white region is a region in which the light field is located. It can be learned from the figure that efficiency of coupling among the transmission waveguide 138, the coupling structure 139, and the dielectric waveguide 131 is high.

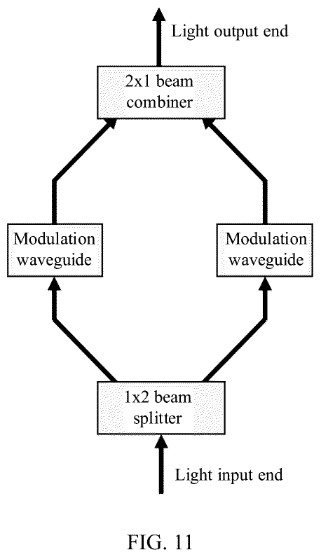

In this embodiment of this application, the electro-optic modulator further includes an optical splitter, to form a Mach-Zehnder interferometer (MZI) structure. FIG. 11 is a schematic diagram of a structure of an electro-optic modulator according to an embodiment of this application. The electro-optic modulator includes a light input end, a 1×2 beam splitter, two modulation waveguides, a 2×1 beam combiner, and a light output end. The optical signal enters through the light input end and is split into two parts by using the 1×2 beam splitter, and the two parts are respectively guided to two light paths of two arms of the MZI structure. The modulation waveguides are disposed on the two arms of the MZI structure, and the electrodes 134 are disposed on two sides of the modulation waveguides. The modulation waveguides may change the phase of the optical signal of the arm under an action of the electric field. Then, the 2×1 beam combiner is configured to combine optical signals of the two arms of the MZI structure, and the optical signals of the two arms interfere with each other, so that a feature of a combined optical signal changes compared with a feature of the optical signal in the light input end, for example, light intensity or a light phase changes. The combined optical signal is output by the light output end. The modulation waveguide on at least one arm may be the foregoing composite waveguide or the organic waveguide 132, and is configured to adjust the light phase under the action of the electric field, to change strength or a phase of the optical signal in the light output end.

During specific implementation, refer to FIG. 9. The electro-optic modulator may further include a first optical splitter 136 (that is, the foregoing 1×2 beam splitter) whose output ends are connected to input ends of two composite waveguides, and a second optical splitter 137 (that is, the foregoing 2×1 beam combiner) whose input ends are connected to output ends of the two composite waveguides, where the first optical splitter 136 and the second optical splitter 137 are located in the dielectric layer 120, and a refractive index of the first optical splitter 136 and a refractive index of the second optical splitter 137 are greater than the refractive index of the dielectric layer 120. In a case in which the modulation waveguides disposed on the two arms of the MZI structure are both the foregoing composite waveguides, that is, the dielectric waveguide 131 is disposed in the organic waveguide 132, for ease of manufacturing, a material of the first optical splitter 136 and a material of the second optical splitter 137 may be consistent with the material of the dielectric waveguide 131, and the first optical splitter 136, the second optical splitter 137, and the dielectric waveguide 131 may be formed simultaneously. The first optical splitter 136, the second optical splitter 137, and the dielectric waveguide 131 may have a same height.

The dielectric waveguide 131 may be connected to the first optical splitter 136, or the dielectric waveguide 131 may be connected to the second optical splitter 137. The first optical splitter 136 and the second optical splitter 137 are separately used as a waveguide to transmit the optical signal. A width of the output end of the first optical splitter 136 and a width of the input end of the second optical splitter 137 are greater than the width of the dielectric waveguide 131. Specifically, the output end of the first optical splitter 136 and the input end of the second optical splitter 137 have a width range of 400 nanometers to 1000 nanometers and a height range of 150 nanometers to 500 nanometers.

The dielectric waveguide 131 and the first optical splitter 136 may be directly connected to each other, or may be connected to each other through the transmission waveguide 138 and/or the coupling structure 139. The dielectric waveguide 131 and the second optical splitter 137 may be directly connected to each other, or may be connected to each other through the transmission waveguide 138 and/or the coupling structure 139. Refer to FIG. 9. The transmission waveguide 138 is disposed between the output end of the first optical splitter 136 and an input end of the coupling structure 139, and an output end of the coupling structure 139 is connected to an input end of the dielectric waveguide 131. The transmission waveguide 138 is disposed between the input end of the second optical splitter 137 and an output end of the another coupling structure 139, and an input end of the another coupling structure 139 is connected to an output end of the dielectric waveguide 131.

An embodiment of this application provides an electro-optic modulator, including a substrate and a dielectric layer located on a side of the substrate. An organic waveguide and electrodes on two sides of the organic waveguide are disposed in the dielectric layer, a refractive index of the organic waveguide is greater than a refractive index of the dielectric layer, and a material of the organic waveguide is an organic material having electro-optic effect. Generally, the material of the organic waveguide is incompatible with a CMOS process. Therefore, the electrodes may be disposed on the two sides of the organic waveguide, and the organic waveguide may be disposed in the dielectric layer. In this way, the organic waveguide may be formed after another CMOS process is completed. Therefore, it may be considered that the organic waveguide is compatible with the another CMOS process. This facilitates chip integration and can be applied to a wider range. In addition, the organic waveguide has a wide operating wavelength range, high linear electro-optic effect, and high modulation efficiency. That is, the electro-optic modulator has high electro-optic modulation efficiency, is conducive to integration, and has higher performance and a wider application scope.

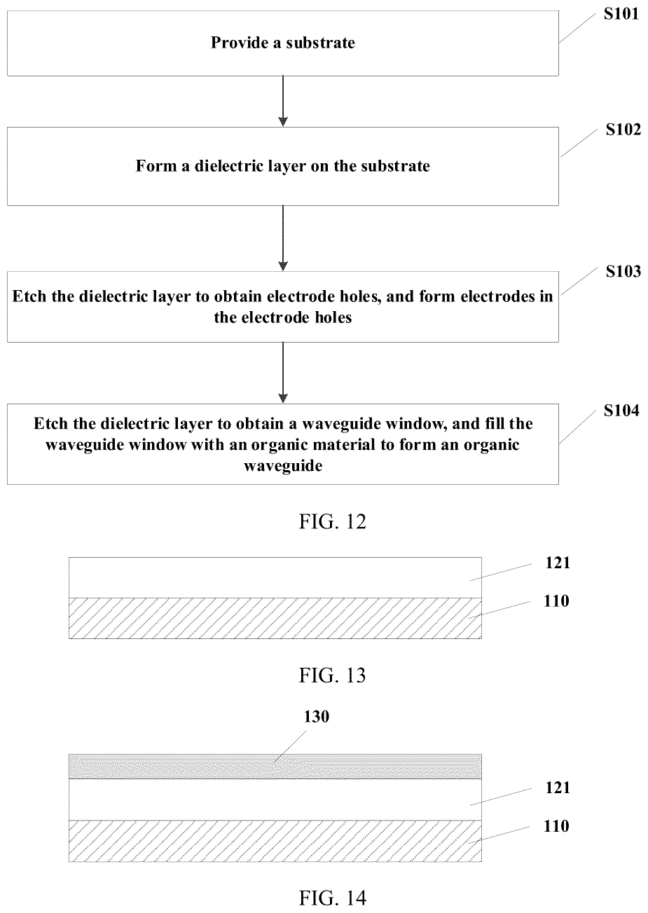

Based on the electro-optic modulator provided in an embodiment of this application, an embodiment of this application further provides a manufacturing method of an electro-optic modulator. FIG. 12 is a flowchart of the manufacturing method of an electro-optic modulator according to an embodiment of this application. FIG. 13 to FIG. 24 are schematic diagrams of structures of the electro-optic modulator in a manufacturing process. The manufacturing method may include the following steps.
S101: Provide a substrate 110, as shown in FIG. 13.

In this embodiment of this application, the substrate 110 may be an insulator substrate, or may be a semiconductor substrate, for example, may be a silicon oxide substrate, a silicon substrate, a germanium substrate, a silicon-germanium substrate, a silicon-on-insulator (SOI) substrate, a germanium-on-insulator (GOI) substrate, or the like. The substrate 110 may provide specific support for a device. A front-end-of-line process may be completed on the substrate 110. For example, at least one photonic layer (not shown in the figure) may be disposed on the substrate 110, and the photonic layer is configured to implement a special electronic-photonic function.
S102: Form a dielectric layer 120 on the substrate 110, as shown in FIG. 13 to FIG. 18.

In this embodiment of this application, the dielectric layer 120 may be formed on the substrate, and a material of the dielectric layer 120 may be silicon oxide. In a case in which the photonic layer is disposed on the substrate 110, the dielectric layer 120 may be disposed on the photonic layer, to implement integration of a plurality of kinds of functional layers.

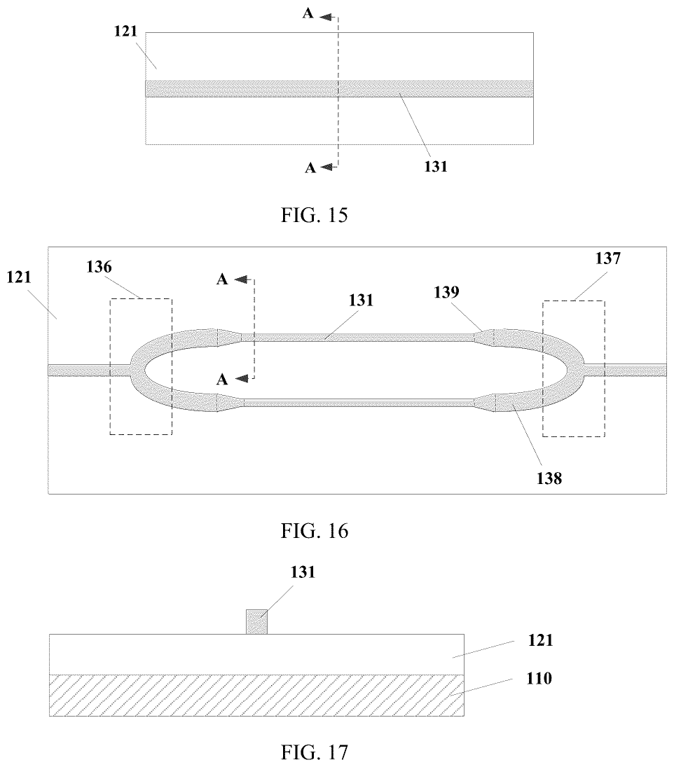

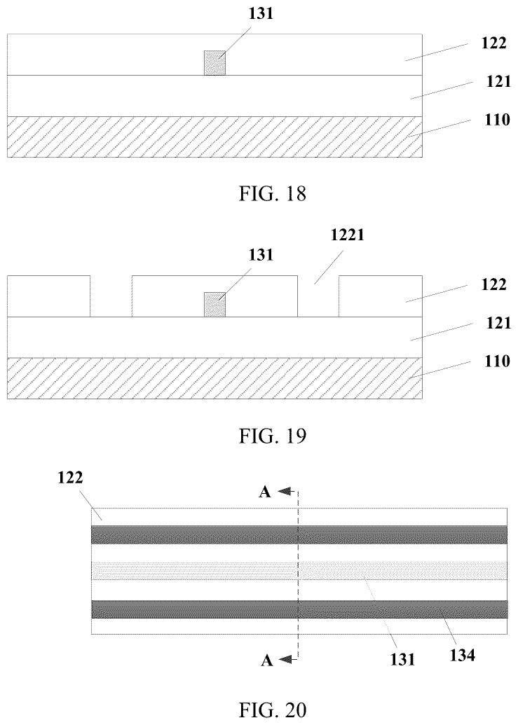

In a case in which the electro-optic modulator includes a dielectric waveguide 131, the dielectric layer 120 may include a first dielectric layer 121 and a second dielectric layer 122. The forming a dielectric layer 120 on the substrate 110 may be specifically: forming the first dielectric layer 121 on the substrate, as shown in FIG. 13, where the first dielectric layer 121 may be formed by using a deposition process, and after the first dielectric layer 121 is obtained through deposition, the first dielectric layer 121 may be flattened by using a chemical mechanical polishing (CMP) process; forming a dielectric material layer 130 on the first dielectric layer 121, as shown in FIG. 14; etching the dielectric material layer 130 to obtain the dielectric waveguide 131, as shown in FIG. 15, FIG. 16, and FIG. 17, where FIG. 17 is a sectional view of the electro-optic modulators shown in FIG. 15 and FIG. 16 in an AA direction, an etching manner of the dielectric material layer 130 may include photoetching and etching, and an etching process may be anisotropic dry etching; and forming, on the first dielectric layer 121, a second dielectric layer 122 covering the dielectric waveguide 131, as shown in FIG. 18, where the second dielectric layer 122 may be formed by using the deposition process, and after the second dielectric layer 122 is obtained through deposition, the second dielectric layer 122 may be flattened by using the CMP process.

The dielectric waveguide 131 has an extension direction, and the extension direction is a propagation direction of an optical signal. For ease of description, a direction parallel to a surface of the substrate 110 is used as a horizontal direction, and a direction perpendicular to the surface of the substrate 110 is used as a longitudinal direction. A size that is of structures such as an organic waveguide 132, the dielectric waveguide 131, and a coupling structure 139, or the like and that is perpendicular to the surface of the substrate 110 is defined as a “height” or “thickness”. A size parallel to the surface of the substrate 110 and perpendicular to the extension direction of the dielectric waveguide 131 is defined as a “width”. A size parallel to the surface of the substrate 110 and parallel to the extension direction of the dielectric waveguide 131 is defined as a “length”.

A refractive index of the dielectric waveguide 131 is greater than a refractive index of the dielectric layer 120, the dielectric waveguide 131 may not have electro-optic effect, and the dielectric waveguide 131 may be transparent on a visible light band. For example, a material of the dielectric waveguide 131 may be one of the following: silicon nitride, hydrogenated amorphous silicon, or titanium dioxide. The dielectric material layer 130 may have a thickness range of 150 nanometers to 500 nanometers. The dielectric waveguide 131 obtained through deposition may also have a thickness range of 150 nanometers to 500 nanometers and may have a width range of 50 nanometers to 300 nanometers. Widths of the dielectric waveguide 131 may be uniform widths, or may be non-uniform widths. That is, widths of different locations of the dielectric waveguide 131 may be consistent, or may be inconsistent. In a case in which the widths of the dielectric waveguide 131 are inconsistent, a minimum width is greater than or equal to 50 nanometers, and a maximum width is less than or equal to 300 nanometers.

In this embodiment of this application, another waveguide may be further disposed, and is configured to transmit the optical signal without modulating the optical signal. That is, the electro-optic modulator in this embodiment of this application may further include a transmission waveguide 138. The transmission waveguide 138 may be a single-mode waveguide. The transmission waveguide 138 may be disposed in the dielectric layer 120. A refractive index of the transmission waveguide 138 is greater than the refractive index of the dielectric layer 120. The dielectric layer 120 is used as a cladding of the transmission waveguide 138. The transmission waveguide 138 may be connected to an input end and/or an output end of the dielectric waveguide 131. For ease of manufacturing, a material of the transmission waveguide 138 may be consistent with the material of the dielectric waveguide 131, and the transmission waveguide 138 and the dielectric waveguide 131 may be formed simultaneously. In other words, while the dielectric material layer 130 is etched to obtain the dielectric waveguide 131, the dielectric material layer 130 may be etched to obtain the transmission waveguide 138, as shown in FIG. 16. The dielectric waveguide 131 and the transmission waveguide 138 may have a same height and different widths. Specifically, a width of the transmission waveguide 138 may be greater than a width of the dielectric waveguide 131. For example, the transmission waveguide 138 may have a height range of 150 nanometers to 500 nanometers and a width range of 400 nanometers to 1000 nanometers.

In this embodiment of this application, the electro-optic modulator may further include the coupling structure 139. The coupling structure 139 may be disposed between the transmission waveguide 138 and the dielectric waveguide 131, to improve efficiency of coupling between the transmission waveguide 138 and the dielectric waveguide 131. Widths of the coupling structure 139 gradually increase from the dielectric waveguide 131 to the transmission waveguide 138. For ease of manufacturing, a material of the coupling structure 139 may be consistent with the material of the dielectric waveguide 131, and the coupling structure 139 and the dielectric waveguide 131 may be formed simultaneously. In other words, while the dielectric material layer 130 is etched to obtain the dielectric waveguide 131, the dielectric material layer 130 may be etched to obtain the coupling structure 139, as shown in FIG. 16. The dielectric waveguide 131 and the coupling structure 139 may have a same height. In other words, the transmission waveguide 138, the coupling structure 139, and the dielectric waveguide 131 may be made of a same material and have a same height, a width of an end that is of the coupling structure 139 and that is connected to the transmission waveguide 138 may be consistent with the width of the transmission waveguide 138, and a width of an end that is of the coupling structure 139 and that is connected to the dielectric waveguide 131 may be consistent with the width of the dielectric waveguide 131. Specifically, the coupling structure 139 has a length range of 5 micrometers to 100 micrometers.

The coupling structure 139 is connected to the transmission waveguide 138, and is connected to the dielectric waveguide 131. The coupling structure 139, the transmission waveguide 138, and the dielectric waveguide 131 may have no obvious distinguishing boundary. That is, the coupling structure 139, the transmission waveguide 138, and the dielectric waveguide 131 may be an integrated structure made of a same type of dielectric material. A difference between the coupling structure 139 and the transmission waveguide 138 lies in that the coupling structure 139 is located in the organic waveguide 132, and a difference between the coupling structure 139 and the dielectric waveguide 131 lies in that the dielectric waveguide 131 has a small size and may limit an optical mode. Therefore, a part that is of the dielectric material of the integrated structure and that is located outside the organic waveguide 132 may be used as the transmission waveguide, a part that is surrounded by the organic waveguide 132, that is located in a middle of a composite waveguide, and whose width is in a first range may be used as the dielectric waveguide 131, and a part that is located at two ends of the composite waveguide and whose width is greater than the width of the dielectric waveguide and is less than a width of the organic waveguide may be used as the coupling structure 139, where the first range may be 50 nanometers to 300 nanometers.

In this embodiment of this application, the electro-optic modulator further includes an optical splitter, to form an MZI structure. Specifically, the electro-optic modulator may further include a first optical splitter 136 whose output ends are connected to input ends of two dielectric waveguides 131, and a second optical splitter 137 whose input ends are connected to output ends of the two dielectric waveguides 131, where the first optical splitter 136 and the second optical splitter 137 are located in the dielectric layer 120, and a refractive index of the first optical splitter 136 and a refractive index of the second optical splitter 137 are greater than the refractive index of the dielectric layer 120. In a case in which the electro-optic modulator includes the dielectric waveguide 131, for ease of manufacturing, a material of the first optical splitter 136 and a material of the second optical splitter 137 may be consistent with the material of the dielectric waveguide 131, and the first optical splitter 136, the second optical splitter 137, and the dielectric waveguide 131 may be formed simultaneously. The first optical splitter 136, the second optical splitter 137, and the dielectric waveguide 131 may have a same height.

In other words, while the dielectric material layer 130 is etched to obtain the dielectric waveguide 131, the dielectric material layer 130 may be etched to obtain the first optical splitter and the second optical splitter. The output ends of the first optical splitter are connected to the input ends of the two dielectric waveguides 131, the input ends of the second optical splitter are connected to the output ends of the two dielectric waveguides 131, and a width of the output end of the first optical splitter and a width of the input end of the second optical splitter are greater than the width of the dielectric waveguide 131. Specifically, the output end of the first optical splitter 136 and the input end of the second optical splitter 137 have a width range of 400 nanometers to 1000 nanometers and a height range of 150 nanometers to 500 nanometers.

The dielectric waveguide 131 and the first optical splitter 136 may be directly connected to each other, or may be connected to each other through the transmission waveguide 138 and/or the coupling structure 139. The dielectric waveguide 131 and the second optical splitter 137 may be directly connected to each other, or may be connected to each other through the transmission waveguide 138 and/or the coupling structure 139. Refer to FIG. 21. The transmission waveguide 138 is disposed between the output end of the first optical splitter 136 and an input end of the coupling structure 139, and an output end of the coupling structure 139 is connected to the input end of the dielectric waveguide 131. The transmission waveguide 138 is disposed between the input end of the second optical splitter 137 and an output end of the another coupling structure 139, and an input end of the coupling structure 139 is connected to an output end of the dielectric waveguide 131.
S103: Etch the dielectric layer 120 to obtain electrode holes 1221, and form electrodes 134 in the electrode holes 1221, as shown in FIG. 19 to FIG. 23.

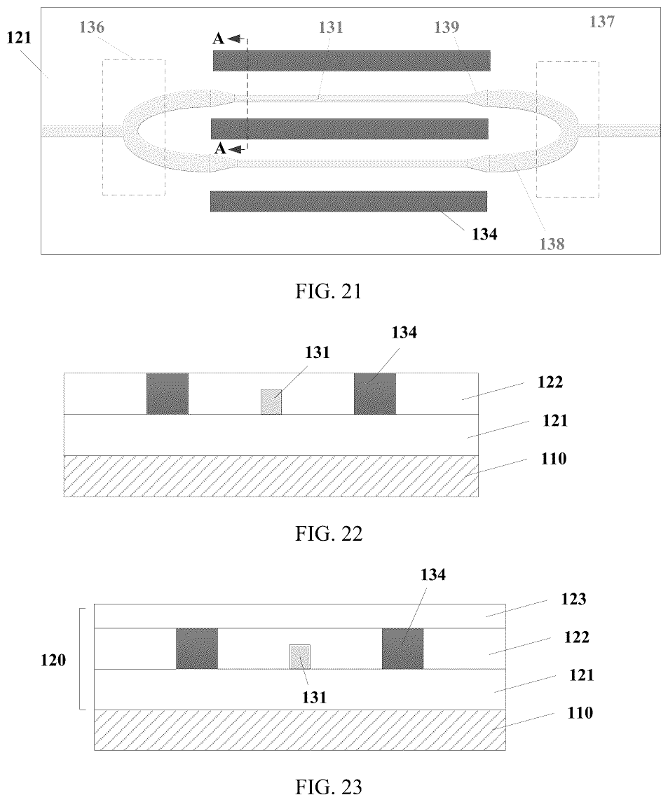

In this embodiment of this application, the dielectric layer 120 may be etched to obtain the electrode holes 1221. The electrode holes 1221 are via holes. Refer to FIG. 19. A forming manner of the electrode holes 1221 may be photoetching and etching, and an etching manner may be anisotropic dry etching. The electrodes 134 may be formed in the electrode holes 1221. Refer to FIG. 20, FIG. 21, and FIG. 22. FIG. 22 is a sectional view of the electro-optic modulators shown in FIG. 20 and FIG. 21 in an AA direction. A material of the electrodes 134 is a material having good electrical conductivity, and the electrodes may be metal electrodes. For example, the material may be at least one of the following: aluminum, copper, or tungsten. A forming process of the electrodes 134 may include deposition, photoetching, and etching. Specifically, an electrode layer may be deposited, and the electrode layer is etched to remove the electrode layer outside the electrode holes.

An etching depth of the dielectric layer 120 may be determined based on an actual requirement. There are at least two electrodes 134. Extension directions of the electrodes 134 are consistent with the extension direction of the dielectric waveguide 131. When a voltage is applied, the electrodes 134 may provide an electric field perpendicular to a transmission direction of the optical signal, to change a refractive index of a waveguide in which the optical signal is located, and to adjust a feature of the optical signal. Generally, the electrodes 134 made of metal absorb light. Therefore, a distance between the electrodes 134 cannot be too short. Otherwise, a serious optical loss is caused. However, if the distance between the electrodes 134 is too long, the electric field between the electrodes 134 is weak under the same voltage. This affects modulation efficiency. Therefore, a horizontal distance between the electrodes 134 may be determined based on requirements for an optical signal loss and the modulation efficiency. Specifically, a distance range of the two electrodes 134 is 2 micrometers to 6 micrometers.

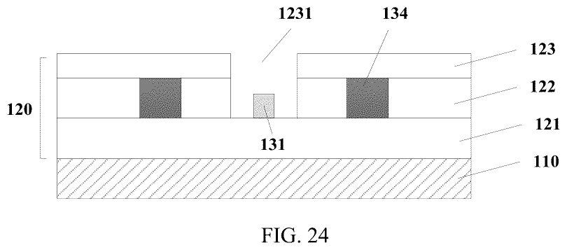

In this embodiment of this application, in a case in which the dielectric layer 120 includes the second dielectric layer 122, upper surfaces of the electrodes 134 may be flush with an upper surface of the second dielectric layer 122, to dispose lead-out structures of the electrodes 134, as shown in FIG. 22. Certainly, a third dielectric layer 123 may be further formed on the second dielectric layer 122, and the third dielectric layer 123 covers the electrodes 134, as shown in FIG. 23. Then, the third dielectric layer 123 may be etched to expose the electrodes (not shown in the figure). In this case, the upper surfaces of the electrodes 134 are lower than a surface of the third dielectric layer 123. That is, the dielectric layer 120 may include the first dielectric layer 121, the second dielectric layer 122, and the third dielectric layer 123, and the upper surfaces of the electrodes 134 may be lower than an upper surface of the dielectric layer 120. Certainly, interconnection structures may be further disposed on the electrodes 134, so that the electrodes 134 are connected to the lead-out structures. This is not illustrated herein and is not described by using an example.
S104: Etch the dielectric layer 120 to obtain a waveguide window 1231, and fill the waveguide window 1231 with an organic material to form the organic waveguide 132, as shown in FIG. 24, FIG. 3, FIG. 4, FIG. 6, and FIG. 9.

In this embodiment of this application, the dielectric layer 120 may be further etched to obtain the waveguide window 1231. The dielectric layer 120 may include the first dielectric layer 121 and the second dielectric layer 122, or may include the first dielectric layer 121, the second dielectric layer 122, and the third dielectric layer 123. The dielectric layer 120 may be etched in a penetrated manner, or may be partially etched.

The waveguide window 1231 is located between the electrode holes 1221. Through filling the waveguide window 1231 with the organic material and polarizing the organic material, the organic waveguide 132 may be formed. The formed organic waveguide 132 is located between the electrodes 134. Different potentials are applied to the electrodes 134 located on different sides of the organic waveguide 132, to generate the electric field. The organic waveguide 132 is located in the electric field, and a refractive index changes under an action of the electric field, to modulate an optical signal in the organic waveguide 132. The formed waveguide window 1231 may expose side walls of the electrodes 134. In other words, the organic waveguide 132 may be in contact with the electrodes 134. Alternatively, the formed waveguide window 1231 may not expose side walls of the electrodes 134, and the organic waveguide 132 and the electrodes 134 are separated by using the dielectric layer 120. In this case, the width of the organic waveguide 132 is less than the distance between the two electrodes 134 located on the two sides of the organic waveguide 132.

Specifically, if a refractive index of the organic waveguide 132 is greater than the refractive index of the dielectric layer 120, the organic waveguide 132 is used as a waveguide core, and the dielectric layer 120 is used as a waveguide cladding. A light field may be limited in the organic waveguide 132 by using a principle of total internal reflection. A material of the organic waveguide 132 is an organic material having electro-optic effect, and has a feature of high modulation efficiency. The organic waveguide 132 can generate an obvious refractive index change in the electric field, and the change may change a transmission feature of the optical signal, for example, change a phase of the optical signal, to implement modulation.

After the filling the waveguide window 1231 with an organic material, a sealing layer 133 may be further formed on the organic material. The sealing layer 133 covers the organic waveguide 132, and is configured to: protect the organic waveguide 132 and prevent an organic material leakage in a forming process of the organic waveguide 132. Then, the organic material may be polarized to obtain the organic waveguide, and a temperature of a processing process is lower than 380° C. A material of the sealing layer 133 may be paraffin. The sealing layer 133 may cover only the organic waveguide 132, or may cover both the organic waveguide 132 and the dielectric layer 120.

In a case in which the electro-optic modulator includes the dielectric waveguide 131, the waveguide window 1231 may expose the upper surface and a side wall of the dielectric waveguide 131, and the formed organic waveguide 132 surrounds the dielectric waveguide 131. In addition, the refractive index of the organic waveguide 132 is less than the refractive index of the dielectric waveguide 131. In other words, a waveguide in this embodiment of this application may be the composite waveguide including the dielectric waveguide 131 and the organic waveguide 132. The dielectric waveguide 131 may limit an optical mode. Therefore, the composite waveguide has a stronger light field limiting capability, so that an optical mode field area is smaller, light absorption by the electrodes 134 is reduced, and this helps achieve a shorter distance between the electrodes 134 without increasing light absorption intensity. Therefore, under a same voltage condition, this enhances horizontal electric field strength, improves overlap efficiency of the electric field and the light field, and improves modulation efficiency of a phase shifter. A shorter modulation region length may be designed to implement an optical signal phase change required for modulation, and to reduce a limitation on a modulation bandwidth. In addition, this helps reduce a size of the phase shifter. In addition, the dielectric waveguide 131 may be transparent on the visible light band, so that an operating wavelength of the electro-optic modulator may expand from infrared/near-infrared to visible light. The dielectric waveguide 131 may have a small size, and is insufficient to limit the optical mode in the dielectric waveguide 131. However, existence of the organic waveguide 132 limits the optical mode in the organic waveguide 132.

Therefore, it should be noted that a larger size of the dielectric waveguide 131 indicates poorer modulation effect on the optical signal, and a smaller size of the dielectric waveguide 131 indicates smaller limiting effect on the optical mode. Therefore, a size of the dielectric waveguide 131 may be appropriately adjusted to balance modulation effect and limiting effect on the optical mode. The dielectric waveguide 131 is disposed in the organic waveguide 132. A size of the organic waveguide 132 is greater than the size of the dielectric waveguide 131. A cross section of the organic waveguide 132 may be a rectangle or a trapezoid. The organic waveguide 132 has a height range of 500 nanometers to 2000 nanometers and a width range of 500 nanometers to 2000 nanometers, so that the organic waveguide 132 is controlled to be in a single-mode state. This facilitates propagation and control of the optical signal. A thickness of the dielectric layer 120 may be greater than a height of the organic waveguide 132, or may be equal to a height of the organic waveguide 132.

In a case in which the electro-optic modulator includes the coupling structure 139, the waveguide window 1231 may further expose an upper surface and a side wall of the coupling structure 139, so that the formed organic waveguide surrounds the coupling structure 139, that is, the coupling structure 139 is disposed in the organic waveguide 132. In this way, the coupling structure 139 and the dielectric waveguide 131 are both disposed in the organic waveguide 132. The coupling structure 139 may be connected to the dielectric waveguide 131, to connect the dielectric waveguide 131 to the transmission waveguide 138. The material of the coupling structure 139 may be consistent with the material of the dielectric waveguide 131. In this case, the refractive index of the organic waveguide 132 is less than a refractive index of the coupling structure 139. In addition, the width of the transmission waveguide 138 may be less than the width of the organic waveguide 132, to reduce an optical loss in a transmission process.

For example, in a case in which materials of the transmission waveguide 138, the coupling structure 139, and the dielectric waveguide 131 are SiN, the width of the transmission waveguide 138 is 1 micrometer, the width of the organic waveguide 132 is 0.4 micrometer, and a length of the coupling structure 139 is 20 micrometers, efficiency of coupling between the transmission waveguide 138 and the composite waveguide is approximately 98%.

In this embodiment of this application, the dielectric layer 120 and the electrodes 134 may be first formed, and then the organic waveguide 132 is formed through filling. That is, the organic waveguide 132 may be formed in a last step, and a manufacturing process does not need a process such as silicon doping or the like. Therefore, a process may be considered to be compatible with a CMOS back-end-of-line process, certainly may also be compatible with another silicon photonic device or CMOS device, and is suitable for multilayer photonics integration. That is, device integration has better scalability, and the process is suitable for a three-dimensional electro-optic integrated circuit with multiple photonic layers.

An embodiment of this application provides a manufacturing method of an electro-optic modulator. The method includes: providing a substrate, forming a dielectric layer on the substrate, etching the dielectric layer to obtain electrode holes and forming electrodes in the electrode holes, and etching the dielectric layer to obtain a waveguide window and filling the waveguide window with an organic material to form an organic waveguide. The electrode holes are located on two sides of the waveguide window, and therefore the electrodes are located on two sides of the organic waveguide. A refractive index of the organic waveguide is greater than a refractive index of the dielectric layer, and a material of the organic waveguide is an organic material having electro-optic effect. A shape of the organic waveguide is set at the end, and it may be considered that the organic waveguide is compatible with another CMOS process. This facilitates chip integration and can be applied to a wider range. In addition, the organic waveguide has a wide operating wavelength range, high linear electro-optic effect, and high modulation efficiency. That is, the electro-optic modulator has high electro-optic modulation efficiency, is conducive to integration, and has higher performance and a wider application scope.

Based on the electro-optic modulator provided in an embodiment of this application, an embodiment of this application further provides an optical communication system. The optical communication system may include at least one electro-optic modulator. In an example, the optical communication system may include a laser, a photodetector, and the foregoing electro-optic modulator. The electro-optic modulator is disposed between the laser and the photodetector, the laser is configured to transmit an optical signal, the electro-optic modulator is configured to perform electro-optic modulation on the optical signal, and the photodetector is configured to detect an optical signal obtained through the electro-optic modulation.

Embodiments in this specification are all described in a progressive manner. For same or similar parts in embodiments, reference may be made to these embodiments, and each embodiment focuses on a difference from other embodiments. Especially, a method embodiment is basically similar to an apparatus embodiment, and therefore is described briefly. For related parts, reference may be made to partial descriptions in the apparatus embodiment.

The foregoing provides specific implementations of this application. It should be understood that the foregoing embodiments are merely intended for describing the technical solutions of this application, but not for limiting this application. Although this application is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of the embodiments of this application.

What is claimed is:

1. An electro-optic modulator, comprising:
a substrate; and
a dielectric layer, disposed on a side of the substrate,
wherein an organic waveguide and electrodes on two sides of the organic waveguide are disposed in the dielectric layer, a refractive index of the organic waveguide is greater than a refractive index of the dielectric layer, and a material of the organic waveguide is an organic material having electro-optic effect.

2. The electro-optic modulator according to claim 1, wherein a dielectric waveguide is disposed in the organic waveguide, the dielectric waveguide and the organic waveguide form a composite waveguide, and a refractive index of the dielectric waveguide is greater than the refractive index of the organic waveguide.

3. The electro-optic modulator according to claim 2, wherein a material of the dielectric waveguide is one of the following: silicon nitride, hydrogenated amorphous silicon, or titanium dioxide.

4. The electro-optic modulator according to claim 2, wherein the dielectric waveguide has a width range of 50 nanometers to 300 nanometers and a height range of 150 nanometers to 500 nanometers.

5. The electro-optic modulator according to claim 2, wherein the dielectric layer further comprises:
a transmission waveguide, wherein a refractive index of the transmission waveguide is greater than the refractive index of the dielectric layer, and the transmission waveguide is connected to an input end and/or an output end of the composite waveguide.

6. The electro-optic modulator according to claim 5, wherein a material of the transmission waveguide is consistent with the material of the dielectric waveguide, the transmission waveguide is connected to the dielectric waveguide, and a width of the transmission waveguide is greater than a width of the dielectric waveguide.

7. The electro-optic modulator according to claim 5, wherein the transmission waveguide has a width range of 400 nanometers to 1000 nanometers and a height range of 150 nanometers to 500 nanometers.

8. The electro-optic modulator according to claim 5, further comprising:
a coupling structure, wherein the coupling structure is connected to the transmission waveguide and the composite waveguide.

9. The electro-optic modulator according to claim 8, wherein the coupling structure is located in the organic waveguide, and is connected to the dielectric waveguide and the transmission waveguide, and widths of the coupling structure gradually increase from an end connected to the dielectric waveguide to an end connected to the transmission waveguide.

10. The electro-optic modulator according to claim 9, wherein a material of the coupling structure is consistent with the material of the dielectric waveguide.

11. The electro-optic modulator according to claim 9, wherein the coupling structure has a length range of 5 micrometers to 100 micrometers.

12. The electro-optic modulator according to claim 2, further comprising:
a first optical splitter whose output ends are connected to input ends of two composite waveguides, and a second optical splitter whose input ends are connected to output ends of the two composite waveguides, wherein the first optical splitter and the second optical splitter are located in the dielectric layer, and a refractive index of the first optical splitter and a refractive index of the second optical splitter are greater than the refractive index of the dielectric layer.

13. The electro-optic modulator according to claim 12, wherein a material of the first optical splitter and a material of the second optical splitter are consistent with the material of the dielectric waveguide, and a width of the output end of the first optical splitter and a width of the input end of the second optical splitter are greater than the width of the dielectric waveguide.

14. The electro-optic modulator according to claim 1, wherein the organic waveguide has a width range of 500 nanometers to 2000 nanometers and a height range of 500 nanometers to 2000 nanometers.

15. The electro-optic modulator according to claim 1, wherein a spacing between the electrodes on the two sides of the organic waveguide is 2 micrometers to 6 micrometers.

16. A manufacturing method of an electro-optic modulator, comprising:
providing a substrate;
forming a dielectric layer on the substrate;
etching the dielectric layer to obtain electrode holes, and forming electrodes in the electrode holes; and
etching the dielectric layer to obtain a waveguide window, and filling the waveguide window with an organic material to form an organic waveguide,
wherein the electrode holes are located on two sides of the waveguide window, a refractive index of the organic waveguide is greater than a refractive index of the dielectric layer, and a material of the organic waveguide is an organic material having electro-optic effect.

17. An optical communication system, comprising a laser, a photodetector, and an electro-optic modulator, wherein the electro-optic modulator is disposed between the laser and the photodetector, the laser is configured to transmit an optical signal, the electro-optic modulator is configured to perform electro-optic modulation on the optical signal, and the photodetector is configured to detect the optical signal obtained through the electro-optic modulation; wherein the electro-optic modulator comprises:
a substrate; and
a dielectric layer, disposed on a side of the substrate, wherein an organic waveguide and electrodes on two sides of the organic waveguide are disposed in the dielectric layer, a refractive index of the organic waveguide is greater than a refractive index of the dielectric layer, and a material of the organic waveguide is an organic material having electro-optic effect.

18. The optical communication system according to claim 17, wherein a dielectric waveguide is disposed in the organic waveguide, the dielectric waveguide and the organic waveguide form a composite waveguide, and a refractive index of the dielectric waveguide is greater than the refractive index of the organic waveguide.

19. The optical communication system according to claim 18, wherein a material of the dielectric waveguide is one of the following: silicon nitride, hydrogenated amorphous silicon, or titanium dioxide.

20. The optical communication system according to claim 18, wherein the dielectric waveguide has a width range of 50 nanometers to 300 nanometers and a height range of 150 nanometers to 500 nanometers.
